(19) United States
(12) Patent Application Publication
(10) Pub. No.: US 2010/0176090 A1
(43) Pub. Date: Jul. 15, 2010

(54) METHOD FOR THE PRODUCTION OF METAL-COATED BASE LAMINATES

(76) Inventors: Rene Lochtman, Mannheim (DE); Jürgen Kaczun, Wachenheim (DE); Norbert Wagner, Mutterstadt (DE); Jürgen Pfister, Speyer (DE); Deiter Hentschel, Boblingen (DE)

Correspondence Address: CONNOLLY BOVE LODGE & HUTZ LLP, P.O. BOX 2207, WILMINGTON, DE, 19899, US

(21) Appl. No.: 12/601,581

(22) PCT Filed: May 20, 2008
(86) PCT No.: PCT/EP08/56146

§ 371 Date: Nov. 24, 2009

(30) Foreign Application Priority Data
May 24, 2007 (EP) 07108827.2

(51) Int. Cl. B32B 37/02; C23F 1/02

(52) U.S. Cl. 216/95; 156/151; 156/247; 156/62.2

(57) ABSTRACT

The invention relates to a method for producing metal-coated base laminates having a support (51) made of an electrically nonconductive material (37), which is coated on at least one side with a metal layer (25, 53). In a first step, a base layer (11) is applied onto a substrate (3) with a dispersion (5), which contains electrolessly and/or electrolytically coatable particles in a matrix material. The matrix material is at least partially cured and/or dried. A metal layer is subsequently formed on the base layer (11) by electroless and/or electrolytic coating. The support (51) made of the electrically nonconductive material (37) is laminated onto the metal layer (25). The support (51) laminated with the metal layer (25) and at least a part of the base layer (11) are subsequently removed from the substrate (3).

The invention relates to a method for producing metal-coated base laminates having a support made of an electrically nonconductive material, which is coated on at least one side with a metal layer.

Such metal-coated base laminates are used, for example, for the production of electrical printed circuit boards. In this case conductor track structures are structured from the metal layer, to which end the parts that are not needed for the conductor track structures are removed. So that no current can flow through the support of the metal-coated base laminates, it is made of an electrically nonconductive material.

In general, for the production of copper-clad base laminates, glass fabric for example is impregnated with a formulation consisting predominantly of epoxy resins and only partially cured. These partially cured base laminates are referred to as “prepregs”. They are interleaved alternately with copper foils to form a stack. The copper foils are predominantly so-called ED types (ED=electrodeposition). Their thicknesses lie between 9 and 400 μm, but for the most part between 12 and 72 μm. This interleaved stack is then placed between two ground steel plates, so-called pressing plates. A multiplicity of these stacks, each comprising a metal plate, copper foil, prepregs, copper coil and metal plate, are subsequently pressed at a temperature in the range of from 120 to 250° C. at a pressure of from 5 to 30 bar. The glass fiber-reinforced epoxy resin is thereby fully cured. At the same time, the individual base laminates thus formed are smoothed by the steel plates.

Since production of the thin copper foil is very expensive, the metal-coated base laminates produced in this way are also very expensive. Furthermore, the handling of copper foils with a thickness of less than 10 μm, and in particular less than 5 μm, is very difficult or impossible since the foil tears. For thin copper foils, i.e. copper foils with a thickness of less than 12 μm, a thicker copper foil, generally with a thickness of 18 μm or 36 μm, is always additionally used as a support. So that the copper is released from the support, a thin chromium layer is generally used as a separating layer.

It is an object of the present invention to provide a method with which metal-coated base laminates, which are already provided with a very thin copper base layer and which do not require additional metal foils as supports, can be produced in a straightforward way.

The object is achieved by a method for producing metal-coated base laminates having a support made of an electrically nonconductive material, which is coated on at least one side with a metal layer, comprising the following steps:
(a) Applying a base layer onto a substrate, with a dispersion which contains electrolessly and/or electrolytically coatable particles in a matrix material,
(b) At least partially curing and/or drying the matrix material,
(c) Forming a metal layer on the base layer by electroless and/or electrolytic coating,
(d) Laminating the support made of the electrically nonconductive material onto the metal layer produced in step (c),
(e) Removing the support laminated with the metal layer and optionally at least a part of the base layer from the substrate.

The advantage of the method according to the invention is that the metal layer can be simultaneously applied in one working step when producing the base laminates. It is not necessary to apply a foil, which may tear. Furthermore, even particularly thin metal layers can be applied by the method according to the invention.

An advantage of using the substrate is that it is recyclable, since in general it is not damaged after removing the coated base laminates. Furthermore, it is also possible to produce the substrate with a defined surface quality and surface structure, so that a predetermined surface quality and surface structure is also achieved for the metal-coated base laminates, according to the surface condition of the substrate.

The substrate is for example a plate or a foil. The foil is preferably flexible. So that the metal layer and optionally a part of the base layer are released from the substrate, the latter is preferably coated with a release agent. As an alternative, it is possible for the substrate to be a plate or foil made of a release agent. In the case of continuous process management it is preferable for the substrate to be provided as a foil, the foil either being coated with the release agent or being made of the release agent, which is stored as a so-called endless foil on a roll. The process may then be carried out as a roll-to-roll process, in which the foil is unwound from a roll, subjected to at least one process step, and preferably all the process steps, and is then wound up again.

All materials which are not damaged by the pressure applied during the lamination and the temperature, which is required for curing the material, are suitable as a material for the substrate. The substrate is preferably made of a metal, for example steel plate which is conventional in the sector, aluminum, a solid aluminum alloy or a solid copper alloy.

If the lamination of the support in step (d) takes place at an elevated temperature relative to the ambient temperature, then it is preferable that the material for the substrate should be a good conductor of heat. The heat transport through the substrate into the interior of the stack is regulated, according to the type of material selected, via the heating curve of the laminating press. In the case of hydraulic static presses, the heat transport into the stack interior is additionally attenuated by adding material outside the plates, for example multi-ply paper. Uniform curing of the material for the support is thereby achieved.

In a first step, a dispersion which contains electrolessly and/or electrolytically coatable particles in a matrix material is applied onto the substrate. All materials that have a high bonding force with the surface of the substrate which is coated with the release agent, and a low bonding force with the dispersion applied thereon, are suitable as a release agent for coating the substrate. The person skilled in the art will select a suitable release agent, depending on the composition of the dispersion. The release agent may be a suitable polymer, for example a polyvinyl alcohol, a silicone polymer or a fluoropolymer or a low molecular weight fat, wax or oil. Release agents which have a low surface tension of less than 30 mN/m relative to air are preferred. These are for example fluoropolymers such as polytetrafluoroethylene (PTFE), polyvinylidene fluoride, polyvinyl fluoride (PVF), ethylene-tetrafluoroethylene (EFE), poly-4-methylpentene-1 (TDX), modified polyesters (e.g. Pacothane™ by Pacothane Technologies), or silicone polymers, for example polydimethylsiloxane polymers, and modified cellulose triacetate (CTA). Polytetrafluoroethylene (PTFE), polyvinyl fluoride (PVF), ethylene-tetrafluoroethylene (EFE), poly-4-methylpentene-1 (TDX), modified polyesters (e.g. Pacothane™ by Pacothane Technologies), and modified cellulose triacetate (CTA) are particularly preferred as release agents. Depending on the temperature during the lamination in step (d), natural waxes or synthetic and semisynthetic waxes may nevertheless also be possible, for example polyolefin waxes or polyimide waxes. Combinations of different release agents are also possible.

The release agent coating may be applied onto the metal plate by any method known to the person skilled in the art. For example, it is possible to provide the substrate with a permanent release agent coating. To this end, the surface is generally roughened first. Release agents containing fluorine, for example PTFE, are for example applied permanently by the plasma method. The release agent may also be applied onto the surface by a solution containing the release agent. The release agent is liberated from the solution by evaporation.

As an alternative, it is also possible to apply a release agent coating which is not permanently bonded to the substrate.

The release agent coating may be applied by any application method known to the person skilled in the art. For example, it is also possible to apply the release agent coating by doctor blading, roller coating, spraying, painting, brushing or the like. Preferably, however, the release agent coating is applied onto the substrate by the plasma method known for example from PTFE coating technology.

As an alternative, in the case of so-called plasma methods which are used for example for coating with PTFE and are known to the person skilled in the art, the release agent layer is applied by means of arc discharge welding.

If the release agent coating is not firmly bonded to the substrate, it is respectively necessary to apply the coating again before applying the dispersion, which contains the electrolessly and/or electrolytically coatable particles.

The electrolessly and/or electrolytically coatable particles may be particles with any geometry made of any electrolessly and/or electrolytically coatable material, mixtures of different electrolessly and/or electrolytically coatable materials or mixtures of electrolessly and/or electrolytically coatable and non-coatable materials. Suitable electrolessly and/or electrolytically coatable materials are for example carbon, for example in the form of carbon black, graphite, graphenes, or carbon nanotubes, electrically conductive metal complexes, conductive organic compounds or conductive polymers or metals, preferably zinc, nickel, copper, tin, cobalt, manganese, iron, magnesium, lead, chromium, bismuth, silver, gold, aluminum, titanium, palladium, platinum, tantalum and alloys thereof or metal mixtures which contain at least one of these metals. Suitable alloys are for example CuZn, CuSn, CuAg, CuNi, SnPb, SnBi, SnCo, NiPb, ZnFe, ZnNi, ZnCo and ZnMn. Aluminum, iron, copper, silver, nickel, zinc, carbon and mixtures thereof are particularly preferred.

The electrolessly and/or electrolytically coatable particles preferably have an average particle diameter of from 0.001 to 100 μm, preferably from 0.002 to 50 μm and particularly preferably from 0.005 to 10 μm. The average particle diameter may be determined by means of laser diffraction measurement, for example using a Microtrac X100 device. The distribution of the particle diameters depends on their production method. The diameter distribution typically comprises only one maximum, although a plurality of maxima are also possible. Thus, for example it is possible to mix particles having an average particle diameter of less than 100 nm with particles having an average particle diameter of more than 1 μm, thereby obtaining a denser particle packing.

The surface of the electrolessly and/or electrolytically coatable particles may at least partially be provided with a coating. Suitable coatings may be inorganic (for example SiO₂, phosphates) or organic in nature. The electrically conductive particles may of course also be coated with a metal or metal oxide. The metal may also be present in a partially oxidized form.

If two or more different metals are intended to form the electrolessly and/or electrolytically coatable particles, then this may be done using a mixture of these metals. In particular, it is preferable for the metals to be selected from the group consisting of aluminum, iron, copper, nickel, silver or zinc.

The electrolessly and/or electrolytically coatable particles may nevertheless also contain a first metal and a second metal, in which the second metal is present in the form of an alloy (with the first metal or one or more other metals), or electrolessly and/or electrolytically coatable particles may contain two different alloys.

Besides the choice of the electrolessly and/or electrolytically coatable particles, the shape of the electrolessly and/or electrolytically coatable particles also has an effect on the properties of the dispersion after coating. In respect of the shape, numerous variants known to the person skilled in the art are possible. The shape of the electrolessly and/or electrolytically coatable particles may, for example, be needle-shaped, cylindrical, platelet-shaped or spherical. These particle shapes represent idealized shapes and the actual shape may differ more or less strongly therefrom, for example owing to production. For example, teardrop-shaped particles are a real deviation from the idealized spherical shape in the scope of the present invention.

Electrolessly and/or electrolytically coatable particles with various particle shapes are commercially available.

When mixtures of electrolessly and/or electrolytically coatable particles are used, the individual mixing partners may also have different particle shapes and/or particle sizes. It is also possible to use mixtures of only one type of electrolessly and/or electrolytically coatable particles with different particle sizes and/or particle shapes. In the case of different particle shapes and/or particle sizes, the metals aluminum, iron, copper, silver, nickel and zinc, as well as carbon are likewise preferred.

As already mentioned above, the electrolessly and/or electrolytically coatable particles may be added in the form of powder to the dispersion. Such powders, for example metal powders, are commercially available goods and may readily be produced by means of known methods, for instance by electrolytic deposition or chemical reduction from solutions of metal salts or by reduction of an oxidic powder, for example by means of hydrogen, by spraying or atomizing a metal melt, particularly into coolants, for example gases or water. Gas and water atomization and the reduction of metal oxides are preferred. Metal powders with the preferred particle size may also be produced by grinding normal coarser metal powder. A ball mill, for example, is suitable for this. Besides gas and water atomization, the carbonyl-iron powder process for producing carbonyl-iron powder is preferred in the case of iron. This is done by thermal decomposition of iron pentacarbonyl. It is described, for example, in Ullman's Encyclopedia of Industrial Chemistry, 5th Edition, Vol. A14, p. 599. The decomposition of iron pentacarbonyl may, for example, take place at elevated temperatures and elevated pressures in a heatable decomposer that comprises a tube of a refractory material such as quartz glass or V2A steel in a preferably vertical position, which is enclosed by a heating instrument, for example consisting of heating baths, heating wires or a heating jacket through which a heating medium flows. Carbonyl-nickel powder can also be produced by a similar method.

Platelet-shaped electrolessly and/or electrolytically coatable particles can be controlled by optimized conditions in the production process or obtained afterward by mechanical treatment, for example by treatment in an agitator ball mill.

Expressed in terms of the total weight of the dried coating, the proportion of electrolessly and/or electrolytically coatable particles preferably lies in the range of from 20 to 98 wt. %. A preferred range for the proportion of the electrolessly and/or electrolytically coatable particles is from 30 to 95 wt. %, expressed in terms of the total weight of the dried coating. Suitable as a matrix material, for example, are binders with a pigment-affine anchor group, natural and synthetic polymers and derivatives thereof, natural resins as well as synthetic resins and derivatives thereof, natural rubber, synthetic rubber, proteins, cellulose derivatives, drying and non-drying oils and the like, They may—but need not—be chemically or physically curing, for example air-curing, radiation-curing or temperature-curing.

The matrix material is preferably a polymer or polymer blend.

Polymers preferred as a matrix material are, for example, ABS (acrylonitrile-butadiene-styrene); ASA (acrylonitrile-styrene acrylate); acrylic acrylates; alkyd resins; alkyl vinyl acetates; alkyl vinyl acetate copolymers, in particular methylene vinyl acetate, ethylene vinyl acetate, butylene vinyl acetate; alkylene vinyl chloride copolymers; amino resins; aldehyde and ketone resins; celluloses and cellulose derivatives, in particular hydroxyalkyl celluloses, cellulose esters such as acetates, propionates, butyrates, carboxyalkyl celluloses, cellulose nitrate; epoxy acrylate; epoxy resins; modified epoxy resins, for example bifunctional or polyfunctional Bisphenol A or Bisphenol F resins, epoxy-novolak resins, brominated epoxy resins, cycloaliphatic epoxy resins; aliphatic epoxy resins, glycidyl ethers, vinyl ethers, ethylene-acrylic acid copolymers; hydrocarbon resins; MABS (transparent ABS also containing acrylate units); melamine resins, maleic acid anhydride copolymers; methacrylates; natural rubber; synthetic rubber; chlorine rubber; natural resins; colophonium resins; shellac; phenol resins; phenoxy resins, polyesters; polyester resins such as phenyl ester resins; polysulfones; polyether sulfones; polyamides; polyimides; polyanilines; polypyrroles; polybutylene terephthalate (PBT); polycarbonate (for example Makrolon® from Bayer AG); polyester acrylates; polyether acrylates; polyethylene; polyethylene thiophene; polyethylene naphthalates; polyethylene terephthalate (PET); polyethylene terephthalate glycol (PETG); polypropylene; polymethyl methacrylate (PMMA); polyphenylene oxide (PPO); polystyrenes (PS), polytetrafluoroethylene (PTFE); polytetrahydrofuran; polyethers (for example polyethylene glycol, polypropylene glycol), polyvinyl compounds, in particular polyvinyl chloride (PVC), PVC copolymers, PVdC, polyvinyl acetate as well as copolymers thereof, optionally partially hydrolyzed polyvinyl alcohol, polyvinyl acetals, polyvinyl acetates, polyvinyl pyrrolidone, polyvinyl ethers, polyvinyl acrylates and methacrylates in solution and as a dispersion as well as copolymers thereof, polyacrylates and polystyrene copolymers, for example polystyrene maleic acid anhydride copolymers; polystyrene (modified or not to be shockproof); polyurethanes, uncrosslinked or crosslinked with isocyanates; polyurethane acrylate; styrene acrylic copolymers; styrene-butadiene block copolymers (for example Styroflex® or Styrolux® from BASF AG, K-Resin™ from CPC); proteins, for example casein; styrene-isoprene block copolymers; triazine resins, bismaleimide-triazine resin (BT), cyanate ester resin (CE), allylated polyphenylene ethers (APPE). Mixtures of two or more polymers may also form the matrix material.

Polymers particularly preferred as a matrix material are acrylates, acrylic resins, cellulose derivatives, methacrylates, methacrylic resins, melamine and amino resins, polyalkylenes, polyimides, epoxy resins, modified epoxy resins, for example bifunctional or polyfunctional Bisphenol A or Bisphenol F resins, epoxy-novolak resins, brominated epoxy resins, cycloaliphatic epoxy resins; aliphatic epoxy resins, glycidyl ethers, vinyl ethers and phenol resins, polyurethanes, polyesters, polyvinyl acetals, polyvinyl acetates, polystyrenes, polystyrene copolymers, polystyrene acrylates, styrene-butadiene block copolymers, triazine resins, bismaleimide-triazine resins (BT), alkenyl vinyl acetates and vinyl chloride copolymers, polyamides and copolymers thereof. Mixtures of two or more of these polymers may also form the matrix material.

The matrix material may for example furthermore contain crosslinkers and catalysts known to the person skilled in the art, for example photoinitiators, tertiary amines, imidazoles, aliphatic and aromatic polyamines, polyamidoamines, anhydrides, BF₃-MEA, phenol resins, styrene-maleic anhydride polymers, hydroxyacrylates, dicyandiamide or polyisocyanates.

As a matrix material for the dispersion in the production of printed circuit boards, it is preferable to use thermally or radiation-curing resins, for example modified epoxy resins such as bifunctional or polyfunctional Bisphenol A or Bisphenol F resins, epoxy-novolak resins, brominated epoxy resins, cycloaliphatic epoxy resins; aliphatic epoxy resins, glycidyl ethers, cyanate esters, vinyl ethers, phenol resins, phenoxy resins, polyimides, melamine resins, amino resins, triazine resins, bismaleimide-triazine resins (BT), polyurethanes, polyesters and cellulose derivatives.

Expressed in terms of the total weight of the dry coating, the proportion of the organic binder components is from 0.01 to 60 wt. %. The proportion is preferably from 0.1 to 45 wt. %, more preferably from 0.5 to 35 wt. %.

In order to be able to apply the dispersion containing the electrolessly and/or electrolytically coatable particles and the matrix material onto the plate coated with the release agent, a solvent or a solvent mixture may furthermore be added to the dispersion in order to adjust the viscosity of the dispersion suitable for the respective application method. Suitable solvents are, for example, aliphatic and aromatic hydrocarbons (for example n-octane, cyclohexane, toluene, xylene), alcohols (for example methanol, ethanol, 1-propanol, 2-propanol, 1-butanol, 2-butanol, amyl alcohol), polyvalent alcohols such as glycerol, ethylene glycol, propylene glycol, neopentyl glycol, alkyl esters (for example methyl acetate, ethyl acetate, propyl acetate, butyl acetate, isobutyl acetate, isopropyl acetate, 3-methyl butanol), alkoxy alcohols (for example methoxypropanol, methoxybutanol, ethoxypropanol), alkyl benzenes (for example ethyl benzene, isopropyl benzene), butyl glycol, dibutyl glycol, alkyl glycol acetates (for example butyl glycol acetate, dibutyl glycol acetate) dimethyl formamide (DMF), diacetone alcohol, diglycol dialkyl ethers, diglycol monoalkyl ethers, dipropylene glycol dialkyl ethers, dipropylene glycol monoalkyl ethers, diglycol alkyl ether acetates, dipropylene glycol alkyl ether acetate, dioxane, dipropylene glycol and ethers, diethylene glycol and ethers, DBE (dibasic esters), ethers (for example diethyl ether, tetrahydrofuran), ethylene chloride, ethylene glycol, ethylene glycol acetate, ethylene glycol dimethyl ester, cresol, lactones (for example butyrolactone), ketones (for example acetone, 2-butanone, cyclohexanone, methyl ethyl ketone (MEK), methyl isobutyl ketone (MIBK)), dimethyl glycol, methylene chloride, methylene glycol, methylene glycol acetate, methyl phenol (ortho-, meta-, para-cresol), pyrrolidones (for example N-methyl-2-pyrrolidone), propylene glycol, propylene carbonate, carbon tetrachloride, toluene, trimethylol propane (IMP), aromatic hydrocarbons and mixtures, aliphatic hydrocarbons and mixtures, alcoholic monoterpenes (for example terpineol), water and mixtures of two or more of these solvents.

Preferred solvents are alcohols (for example ethanol, 1-propanol, 2-propanol, butanol), alkoxyalcohols (for example methoxy propanol, ethoxy propanol, butyl glycol, dibutyl glycol), butyrolactone, diglycol dialkyl ethers, diglycol monoalkyl ethers, dipropylene glycol dialkyl ethers, dipropylene glycol monoalkyl ethers, propylene glycol monoalkyl ethers, esters (for example ethyl acetate, butyl acetate, butyl glycol acetate, dibutyl glycol acetate, diglycol alkyl ether acetates, dipropylene glycol alkyl ether acetates, propylene glycol alkyl ether acetates, DBE), ethers (for example tetrahydrofuran), polyvalent alcohols such as glycerol, ethylene glycol, propylene glycol, neopentyl glycol, ketones (for example acetone, methyl ethyl ketone, methyl isobutyl ketone, cyclohexanone), hydrocarbons (for example cyclohexane, ethyl benzene, toluene, xylene), DMF, N-methyl-2-pyrrolidone, water and mixtures thereof.

In the case of liquid matrix materials (for example liquid epoxy resins, acrylic esters), the respective viscosity may alternatively be adjusted via the temperature during application, or via a combination of a solvent and temperature.

The dispersion may furthermore contain a dispersant component. This consists of one or more dispersants.

In principle, all dispersants known to the person skilled in the art for application in dispersions and described in the prior art are suitable. Preferred dispersants are surfactants or surfactant mixtures, for example anionic, cationic, amphoteric or nonionic surfactants.

Cationic and anionic surfactants are described, for example, in “Encyclopedia of Polymer Science and Technology”, J. Wiley & Sons (1966), Vol. 5, pp. 816-818, and in “Emulsion Polymerisation and Emulsion Polymers”, ed. P. Lovell and M. El-Asser, Wiley & Sons (1997), pp. 224-226.

It is nevertheless also possible to use polymers known to the person skilled in the art having pigment-affine anchor groups as dispersants.

The dispersant may be used in the range of from 0.01 to 50 wt. %, expressed in terms of the total weight of the dispersion. The proportion is preferably from 0.1 to 25 wt. %, particularly preferably from 0.2 to 10 wt. %.

The dispersion according to the invention may furthermore contain a filler component.

This may consist of one or more fillers. For instance, the filler component of the metallizable mass may contain fillers in fiber, layer or particle form, or mixtures thereof. These are preferably commercially available products, for example mineral fillers.

It is furthermore possible to use fillers or reinforcers such as glass powder, mineral fibers, whiskers, aluminum hydroxide, metal oxides such as aluminum oxide or iron oxide, mica, quartz powder, calcium carbonate, magnesium silicate (talc), barium sulfate, titanium dioxide or wollastonite.

Other additives may furthermore be used, such as thixotropic agents, for example silica, silicates, for example aerosils or bentonites, or organic thixotropic agents and thickeners, for example polyacrylic acid, polyurethanes, hydrated castor oil, dyes, fatty acids, fatty acid amides, plasticizers, networking agents, defoaming agents, lubricants, desiccants, crosslinkers, photoinitiators, sequestrants, waxes, pigments, conductive polymer particles.

The proportion of the filler component is preferably from 0.01 to 50 wt. %, expressed in terms of the total weight of the dry coating. From 0.1 to 30 wt. % are further preferred, and from 0.3 to 20 wt. % are particularly preferred.

There may furthermore be processing auxiliaries and stabilizers in the dispersion according to the invention, such as UV stabilizers, lubricating agents, corrosion inhibitors and flame retardants. Their proportion is usually from 0.01 to 5 wt. %, expressed in terms of the total weight of the dispersion. The proportion is preferably from 0.05 to 3 wt. %.

After having applied the base layer onto the substrate with the dispersion, which contains the electrolessly and/or electrolytically coatable particles in the matrix material, the matrix material is at least partially cured and/or dried. The drying and/or curing is carried out according to conventional methods. For example, the matrix material may be cured chemically, for example by polymerization, polyaddition or polycondensation of the matrix material, for example by UV radiation, electron radiation, electrowave radiation, IR radiation or temperature, or dried purely chemically by evaporating the solvent. A combination of drying by physical and chemical means is also possible.

By using particles with an average particle diameter of less than 100 nm it is preferred to carry out an additional temperature treatment after applying and drying of the layer to sinter the particles together. This temperature treatment is carried out in general at temperatures in the range from 80 to 300° C., preferably in the range from 100 to 250° C. and particularly in the range from 180 to 200° C. in a time period in the range from 1 to 60 min, preferably from 2 to 30 min and particularly from 4 to 15 min.

In one embodiment, the electrolessly and/or electrolytically coatable particles contained in the dispersion are at least partially exposed after the at least partial drying or curing, so that electrolessly and/or electrolytically coatable nucleation sites are already obtained, onto which the metal ions can be deposited to form a metal layer during the subsequent electroless and/or electrolytic coating. If the particles consist of materials which are readily oxidized, it is sometimes also necessary to remove the oxide layer at least partially beforehand. Depending on the way in which the method is carried out, for example when using acidic electrolyte solutions, the removal of the oxide layer may already take place simultaneously as the metallization is carried out, without an additional process step being necessary.

An advantage of exposing the particles before the electroless and/or electrolytic coating is that in order to obtain a continuous electrically conductive surface, by exposing the particles the coating only needs to contain a proportion of electrolessly and/or electrolytically coatable particles which is about 5 to 15 wt. % lower than is the case when the particles are not exposed. Further advantages are the homogeneity and continuity of the coatings being produced and the high process reliability.

The electrolessly and/or electrolytically coatable particles may be exposed either mechanically, for example by crushing, grinding, milling, sand-blasting or spraying with supercritical carbon dioxide, physically, for example by heating, laser, UV light, corona or plasma discharge, or chemically. In the case of chemical exposure, it is preferable to use a chemical or chemical mixture which is compatible with the matrix material. In the case of chemical exposure, either the matrix material may be at least partially dissolved on the surface and washed away, for example by a solvent on the surface, or the chemical structure of the matrix material may be at least partially disrupted by means of suitable reagents so that the electrolessly and/or electrolytically coatable particles are exposed. Reagents which make the matrix material tumesce are also suitable for exposing the electrolessly and/or electrolytically coatable particles. The tumescence creates cavities which the metal ions to be deposited can enter from the electrolyte solution, so that a larger number of electrolessly and/or electrolytically coatable particles can be metallized. The bonding, homogeneity and continuity of the metal layer subsequently deposited electrolessly and/or electrolytically are significantly better than in the methods described in the prior art. The process rate of the metallization is also higher because of the larger number of exposed electrolessly and/or electrolytically coatable particles, so that additional cost advantages can be achieved.

If the matrix material is for example an epoxy resin, a modified epoxy resin, an epoxy-novolak, a polyacrylate, ABS, a styrene-butadiene copolymer or a polyether, the electrolessly and/or electrolytically coatable particles are preferably exposed by using an oxidizing agent. The oxidizing agent breaks bonds of the matrix material, so that the binder can be dissolved and the particles can thereby be exposed. Suitable oxidizing agents are, for example, manganates such as for example potassium permanganate, potassium manganate, sodium permanganate, sodium manganate, hydrogen peroxide, oxygen, oxygen in the presence of catalysts such as for example manganese salts, molybdenum salts, bismuth salts, tungsten salts and cobalt salts, ozone, vanadium pentoxide, selenium dioxide, ammonium polysulfide solution, sulfur in the presence of ammonia or amines, manganese dioxide, potassium ferrate, dichromate/sulfuric acid, chromic acid in sulfuric acid or in acetic acid or in acetic anhydride, nitric acid, hydroiodic acid, hydrobromic acid, pyridinium dichromate, chromic acid-pyridine complex, chromic acid anhydride, chromium(VI) oxide, periodic acid, lead tetraacetate, quinone, methylquinone, anthraquinone, bromine, chlorine, fluorine, iron(III) salt solutions, disulfate solutions, sodium percarbonate, salts of oxohalic acids such as for example chlorates or bromates or iodates, salts of perhalic acids such as for example sodium periodate or sodium perchlorate, sodium perborate, dichromates such as for example sodium dichromate, salts of persulfuric acids such as potassium peroxodisulfate, potassium peroxomonosulfate, pyridinium chlorochromate, salts of hypohalic acids, for example sodium hypochloride, dimethyl sulfoxide in the presence of electrophilic reagents, tert-butyl hydroperoxide, 3-chloroperbenzoate, 2,2-dimethylpropanal, Des-Martin periodinane, oxalyl chloride, urea hydrogen peroxide adduct, urea hydrogen peroxide, 2-iodoxybenzoic acid, potassium peroxomonosulfate, m-chloroperbenzoic acid, N-methylmorpholine-N-oxide, 2-methylprop-2-yl hydroperoxide, peracetic acid, pivaldehyde, osmium tetraoxide, oxone, ruthenium(III) and (IV) salts, oxygen in the presence of 2,2,6,6-tetramethylpiperidinyl-N-oxide, triacetoxiperiodinane, trifluoroperacetic acid, trimethyl acetaldehyde, ammonium nitrate. The temperature during the process may optionally be increased in order to improve the exposure process.

Preferred are manganates, for example potassium permanganate, potassium manganate, sodium permanganate; sodium manganate, hydrogen peroxide, N-methylmorpholine-N-oxide, percarbonates, for example sodium or potassium percarbonate, perborates, for example sodium or potassium perborate; persulfates, for example sodium or potassium persulfate; sodium, potassium and ammonium peroxodi- and monosulfates, sodium hydrochloride, urea hydrogen peroxide adducts, salts of oxohalic acids such as for example chlorates or bromates or iodates, salts of perhalic acids such as for example sodium periodate or sodium perchlorate, tetrabutylammonium peroxidisulfate, quinone, iron(III) salt solutions, vanadium pentoxide, pyridinium dichromate, hydrochloric acid, bromine, chlorine, dichromates.

Particularly preferred are potassium permanganate, potassium manganate, sodium permanganate, sodium manganate, hydrogen peroxide and its adducts, perborates, percarbonates, persulfates, peroxodisulfates, sodium hypochloride and perchlorates.

In order to expose the electrolessly and/or electrolytically coatable particles in a matrix material which contains for example ester structures such as polyester resins, polyester acrylates, polyether acrylates, polyester urethanes, it is preferable for example to use acidic or alkaline chemicals and/or chemical mixtures. Preferred acidic chemicals and/or chemical mixtures are, for example, concentrated or dilute acids such as hydrochloric acid, sulfuric acid, phosphoric acid or nitric acid. Organic acids such as formic acid or acetic acid may also be suitable, depending on the matrix material. Suitable alkaline chemicals and/or chemical mixtures are, for example, bases such as sodium hydroxide, potassium hydroxide, ammonium hydroxide or carbonates, for example sodium carbonate, calcium carbonate.

The temperature during the process may optionally be increased in order to improve the exposure process.

Solvents may also be used to expose the electrolessly and/or electrolytically coatable particles in the matrix material. The solvent must be adapted to the matrix material, since the matrix material must dissolve in the solvent or be tumesced by the solvent. When using a solvent in which the matrix material dissolves, the base layer is brought in contact with the solvent only for a short time so that the upper layer of the matrix material is solvated and thereby dissolved. Preferred solvents are xylene, toluene, halogenated hydrocarbons, acetone, methyl ethyl ketone (MEK), methyl isobutyl ketone (MIBK), diethylene glycol monobutyl ether. The temperature during the dissolving process may optionally be increased in order to improve the dissolving behavior.

Furthermore, it is also possible to expose the electrolessly and/or electrolytically coatable particles by using a mechanical method. Suitable mechanical methods are, for example, crushing, grinding, polishing with an abrasive or pressure spraying with a water jet, sandblasting or spraying with supercritical carbon dioxide. The top layer of the cured, printed structured base layer is respectively removed by such a mechanical method. The electrolessly and/or electrolytically coatable particles contained in the matrix material are thereby exposed.

All abrasives known to the person skilled in the art may be used as abrasives for polishing. A suitable abrasive is, for example, pumice powder. In order to remove the top layer of the cured dispersion by pressure blasting, the water jet preferably contains small solid particles, for example pumice powder (Al₂O₃) with an average particle size distribution of from 40 to 120 μm, preferably from 60 to 80 μm, as well as quartz powder (SiO₂) with a particle size >3 μm.

If the electrolessly and/or electrolytically coatable particles contain a material which is readily oxidized, in a preferred method variant the oxide layer is at least partially removed before the metal layer is formed on the structured or surface-wide base layer. The oxide layer may in this case be removed chemically and/or mechanically, for example. Suitable substances with which the base layer can be treated in order to chemically remove an oxide layer from the electrolessly and/or electrolytically coatable particles are, for example, acids such as concentrated or dilute sulfuric acid or concentrated or dilute hydrochloric acid, citric acid, phosphoric acid, amidosulfonic acid, formic acid, acetic acid.

Suitable mechanical methods for removing the oxide layer from the electrolessly and/or electrolytically coatable particles are generally the same as the mechanical methods for exposing the particles.

The base layer is preferably applied with the dispersion by a conventional and widely known coating method. Such coating methods are for example casting, painting, doctor blading, spraying, immersion, roller coating or the like. As an alternative, it is also possible to print the base layer onto the support by any printing method. The printing method with which the base layer is printed is, for example, a roll or a sheet printing method such as for example screen printing, intaglio printing, flexographic printing, typography, pad printing, inkjet printing, the Lasersonic® method as described in DE-A 100 51 850, offset printing or a magnetographic printing method. Any other printing method known to the person skilled in the art may, however, also be used. The layer thickness of the base layer, produced by the coating method or by the printing, preferably varies between 0.01 and 50 μm, more preferably between 0.05 and 25 μm and particularly preferably between 0.1 and 15 μm. The layers may be applied in a surface-wide or structured manner. A plurality of layers may also be applied in succession.

Differently fine structures can be printed directly, depending on the printing method.

The dispersion is preferably stirred or pumped around in a storage container before application. Stirring and/or pumping prevents possible sedimentation of the particles contained in that dispersion. Furthermore, it is likewise advantageous for the dispersion to be thermally regulated in the storage container. This makes it possible to achieve an improved printing impression of the base layer on the support, since a constant viscosity can be adjusted by thermal regulation. Thermal regulation is necessary in particular whenever, for example, the dispersion is heated by the energy input of the stirrer or pump when stirring and/or pumping and its viscosity therefore changes. In order to increase the flexibility and for cost reasons, digital printing methods such as example LaserSonic® are particularly suitable in the case of printing application. These methods generally obviate the costs for the production of printing templates, for example printing rolls or screens, as well as their constant changing when a plurality of different structures need to be printed successively. In digital printing methods, it is possible to change over to a new design immediately, without refitting times and stoppages. When structured printing is intended to be carried out constantly with the same layouts, the conventional printing methods such as intaglio, flexographic, screen printing or magnetographic printing methods are preferred.

The electroless and/or electrolytic coating may in this case be carried out using any method known to the person skilled in the art. Any conventional metal coating may moreover be applied. In this case the composition of the electrolyte solution, which is used for the coating, depends on the metal with which the electrically conductive structures on the substrate are intended to be coated. In principle all metals may be used for the electroless and/or electrolytic coating. Conventional metals which are deposited onto electrically conductive surfaces by electroless and/or electrolytic coating are, for example, gold, nickel, palladium, platinum, silver, tin, copper or chromium. The thicknesses of the one or more deposited layers lie in the conventional range known to the person skilled in the art. In the case of electroless coating, all metals which are nobler than the least noble metal of the dispersion may be used.

Suitable electrolyte solutions, which are used for coating electrically conductive structures, are known to the person skilled in the art for example from Werner Jillek, Gusti Keller, Handbuch der Leiterplattentechnik [Handbook of printed circuit technology], Eugen a Leuze Verlag, 2003, volume 4, pages 332-352.

In the case of the electrolytic coating, for example, in order to produce the metal layer, in general the substrate coated with the dispersion is first sent to the bath of the electrolyte solution. The substrate is then transported through the bar, the electrolessly and/or electrolytically coatable particles contained in the previously applied base layer being contacted by at least one cathode. Here, any suitable conventional cathode known to the person skilled in the art may be used. For as long as the cathode contacts the base layer, metal ions are deposited from the electrolyte solution to form a metal layer on the base layer.

After the metal layer has been formed on the base layer, the support made of the electrically nonconductive material is laminated on. In a preferred embodiment, to this end a formable electrically nonconductive material, from which the support is produced, is applied onto the metal layer produced in step (c). The formable electrically nonconductive material is preferably provided in the form of semi-cured plastic plates. The semi-cured plastic plates are preferably reinforced. The plastic plates are furthermore preferably solid and dry to the touch, and therefore regularly handleable. The application of the material for the support onto the metal layer is carried out manually or by automated methods known to the person skilled in the art.

As an alternative, it is also possible for the formable electrically conductive material, from which the support is produced, to be provided for application onto the metal layer as a viscous liquid or as a paste, or in the form of resin-impregnated fibers or mats. The material for the support is applied by any application method known to the person skilled in the art. Suitable application methods are for example painting, casting, doctor blading, spraying, roller application or printing. In the case of fibers or mats, the application is preferably carried out by placement.

If the material for the support is provided in a paste-like form, it is preferable for the material to be applied onto the metal layer for example by printing, casting, roller application, extruding or doctor blading.

In order to improve the adhesion of the applied metal layer on the support, if so required, the support and/or the metal layer may be pretreated by methods known to the person skilled in the art before the metal layer is laminated on, for example by applying an additional bonding or adhesive layer. As a bonding promoter, for example, it is possible to use so-called black or brown oxides based on NaClO₂/NaOH, silanes or polyethyleneimine solutions, for example Lupasol brands from BASF AG or commercially available bonding promoters.

If the metal-coated base laminate is intended to be provided with a metal layer on its upper side and its lower side, then, after the formable electrically nonconductive material has been applied, a further substrate provided with a metal layer is placed onto the formable electrically nonconductive material so that the metal layer comes in contact with the material for the support. If the metal-coated base laminate is intended to be provided with a metal layer only on one side, then a substrate without a metal layer applied thereon is placed onto the material for the support. As described above, the substrate is in this case preferably coated with the release agent so that the release agent is arranged between the substrate and the metal layer, or is made from the release agent. The lamination of the support onto the metal layer is generally carried out by pressing at elevated temperature. The temperature preferably lies in the range of from 120 to 250° C.

The pressure, with which the material contained between the substrates is pressed, preferably lies in the range of from 0.1 to 100 bar, particularly in the range of from 5 to 40 bar.

The duration for which the curing is carried out to form the metal-coated base laminate generally lies in the range of from 1 to 360 minutes, preferably in the range of from 15 to 220 minutes and particularly preferably in the range of from 30 to 90 minutes.

A suitable material for the support is for example any reinforced or unreinforced polymer, such as is conventionally used for printed circuit boards. Suitable polymers are for example bifunctional or polyfunctional Bisphenol A or Bisphenol F resins, epoxy-novolak resins, brominated epoxy resins, cycloaliphatic epoxy resins, bismaleimide-triazine resins, polyimides, phenol resins, cyanate esters, melamine resins or amino resins, phenoxy resins, allylated polyphenylene ethers (APPE), polysulfones, polyamides, silicone and fluorine resins and combinations thereof. The material for the support may for example furthermore contain additives known to the person skilled in the art, such as crosslinkers and catalysts, for example tertiary amines, imidazoles, aliphatic and aromatic polyamines, polyamidoamines, anhydrides, BF₃-MEA, phenol resins, styrene-maleic anhydride polymers, hydroxyacrylates, dicyandiamide or polyisocyanates, as well as flame retardants and fillers, for example fillers or inorganic nature such as talc, layer silicates, aluminum oxides, aluminum hydroxide or glass.

Furthermore, other polymers and additives conventional in the printed circuit board industry are also suitable.

For the production of electrical printed circuit boards, reinforced supports are preferably used. Suitable fillers for the reinforcement are for example paper, glass fibers, glass nonwovens, glass fabrics, aramid fibers, aramid nonwovens, aramid fabrics, PTFE fabric, PTFE foil sheet.

Depending on the thickness of the metal-coated base laminate being produced, it may be rigid or flexible after the pressing.

In order to be able to produce a plurality of metal-coated base laminates simultaneously, in a preferred embodiment a plurality of levels of the substrate, which is coated with a metal layer, and the formable electrically nonconductive material are stacked alternatively on one another before the lamination. It is in this case necessary to ensure that when base laminates provided with a metal layer on both sides are intended to be produced, those sides of the substrate onto which the metal layer has been applied respectively come in contact with the formable electrically nonconductive material. As described above, the substrate is preferably provided with the release agent so that the release agent is arranged between the substrate and the metal layer, or is made from the release agent. By coating the substrate with the release agent, then, after the support has been laminated onto the metal layer, the support can be removed from the substrate together with the metal layer.

In order to produce the metal-coated base laminate, the stack of substrates provided with the metal layer and the formable electrically nonconductive material is pressed. To this end, for example, the stack is introduced into the opening of a hydraulic press, between the heating and pressure plates, and is processed further according to the process sequences known to the person skilled in the art for the conventional fabrication of base materials.

The metal layer on the substrate may be provided with a bonding promoter, in order to increase the adhesion with the support. This may be a commercially available black or brown oxide process or the application of a silane finish, as well as polyethyleneimine solutions such as for example the Lupasol brands from BASF AG.

The pressing is conventionally carried out at a pressure in the range of from 0.1 to 100 bar, preferably at a pressure in the range of from 5 to 40 bar. When using formable electrically nonconductive materials which cure with an elevated temperature, the pressing is preferably carried out at elevated temperature. The temperature selected will depend on the material being used. The temperature is preferably from 100 to 300° C., particularly preferably from 120 to 230° C. For example, standard FR4 epoxy resins systems are compressed at from 175 to 180° C. More highly crosslinked systems require up to 225° C. The pressing pressure is preferably selected between 15 bar and 30 bar for such resins.

During the pressing, the formable electrically nonconductive material is preferably cured at least partially. In this way a metal-coated base laminate, which can be processed further, will have been formed after the pressing.

The thickness of the support will be set by the amount of the formable electrically nonconductive material, its resin content and the pressing pressure. The surface quality of the metal-coated base laminate produced in this way generally corresponds to the surface condition of the substrate.

By appropriate structuring of the substrate, the base layer can be laminated in an already structured way onto the support. This will simplify subsequent processing, for example to produce printed circuit boards.

After the electrically nonconductive material has been laminated onto the metal layer, the support with the laminated metal layer and optionally at least a part of the base layer is removed from the substrate. Since the metal layer, which has been applied onto the dispersion with the electrolessly and/or electrolytically coatable particles, will however sometimes not have fully replaced the dispersion, after the support has been laminated onto the metal layer the upper side of the support is provided with a layer, which optionally also contains electrolessly and/or electrolytically coatable particles in a material matrix. The continuous metal layer faces the support. In order to achieve a continuous electrically conductive layer on the support in one embodiment, after removing the support with the metal layer laminated thereon, in a further step it is preferable to deposit electrolessly and/or electrolytically coatable metal onto the base layer which is bonded to the support. This is done by conventional methods known to the person skilled in the art. Before the electroless and/or electrolytic deposition of metal, the electrolessly and/or electrolytically coatable particles contained in the base layer, which is bonded to the metal layer laminated on the support, are preferably exposed at least partially after removing the plate coated with the release agent. The electrolessly and/or electrolytically coatable particles are in this case exposed, as described above, similarly as the exposure of the electrolessly and/or electrolytically coatable particles of the dispersion which was applied onto the substrate.

Owing to the electroless and/or electrolytic deposition of metal onto the base layer, which was laminated onto the support, a continuous electrically conductive metal layer is produced.

In another embodiment, the possibly remaining parts of the base layer are removed. To this end, the base layer is subjected to a treatment which corresponds to that described above for exposing the electrolessly and/or electrolytically coatable particles. Like the exposure of the electrolessly and/or electrolytically coatable particles, the removal of the base layer may also be carried out chemically or mechanically. The treatment will be carried out until the matrix material is completely dissolved or removed. In this way the electrolessly and/or electrolytically coatable particles still remaining, which are contained in the layer, are also removed. A pure metal layer, made of the metal which has been applied electrolessly and/or electrolytically, is left remaining.

After pressing and curing the formable electrically nonconductive material and laminating the metal layer on, the base laminate metal-coated in this way is preferably processed further. For example, it is possible to cut the metal-coated base laminate to size. To this end, the individual layers may be sliced into plates of predetermined size.

An electrically conductive structure is preferably produced from the applied metal layer. The electrically conductive structure is generally produced by methods known to the person skilled in the art. Suitable methods are for example plasma etching, photoresist methods or laser ablation methods.

The invention will be described in more detail below with the aid of drawings, in which:

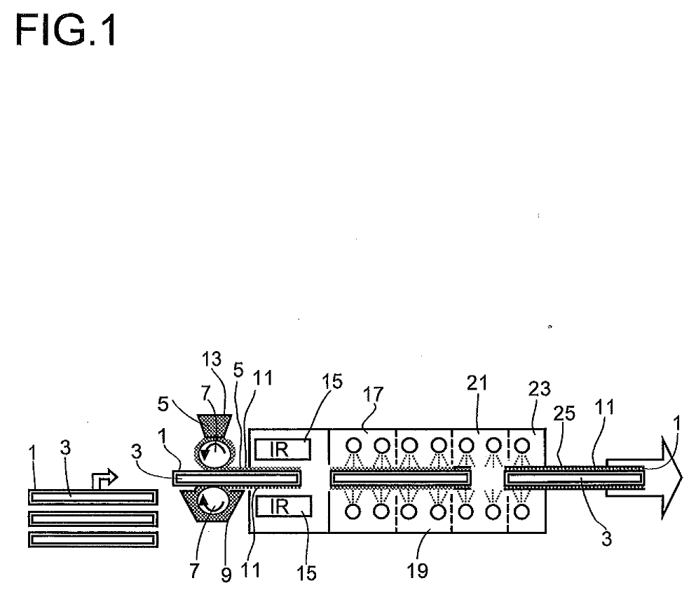

FIG. 1 shows a method sequence for applying a metal layer onto a substrate coated with a release agent,

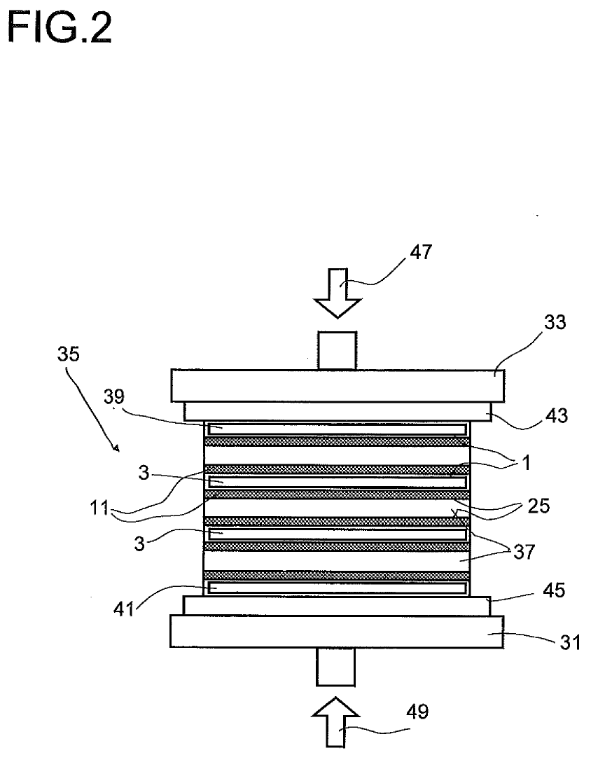

FIG. 2 shows the lamination of the metal layer onto a support,

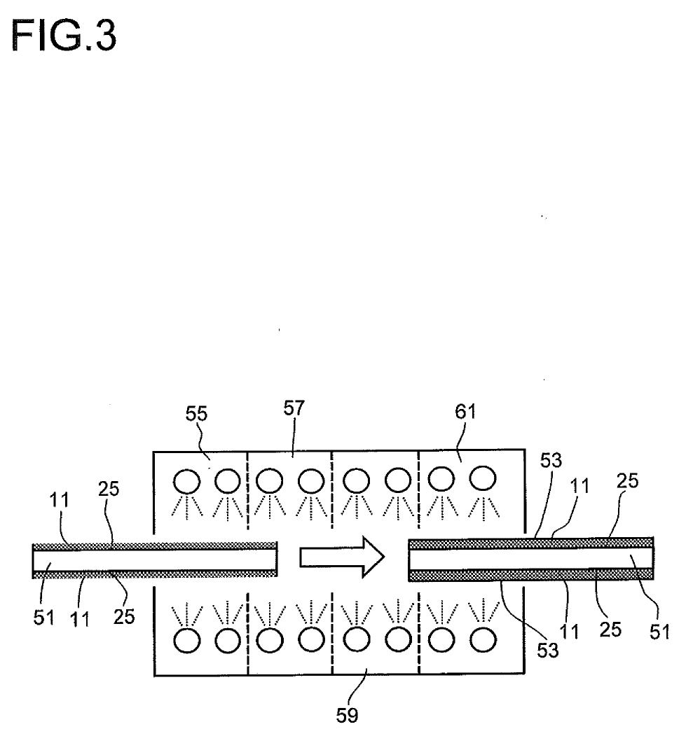

FIG. 3 shows coating of the base layer laminated onto the support.

FIG. 1 represents the application of a metal layer onto a substrate coated with a release agent.

A dispersion 5, which contains electrolessly and/or electrolytically coatable particles, is applied onto a substrate 3 in the form of a plate, coated with a release agent 1. The dispersion containing the electrolessly and/or electrolytically coatable particles may be applied onto the substrate 3 coated with the release agent 1 by any application method known to the person skilled in the art. In the embodiment represented here, the dispersion 5 is applied onto the substrate 3 coated with the release agent 1 with the aid of rollers 7, which are loaded with the dispersion 5. In order to coat the lower side of the substrate 3 with the dispersion 5, the roller 7 is preferably immersed into a container 9 so that the roller 7 becomes coated with the dispersion. By contact with the substrate 3 coated with the release agent 1, a part of the dispersion 5 is transferred from the roller 7 onto the substrate 3. A base layer 11 is formed on the substrate 3 coated with the release agent 1.

In order to coat the upper side of the substrate 3 coated with the release agent 1, it is for example possible to apply the dispersion 5 from a container 13 onto the roller 7 and then from the latter onto the substrate 3 coated with the release agent 1. Besides the method represented here, in which the dispersion 5 is applied onto the substrate 3 coated with the release agent 1 with the aid of rollers 7, any other coating method by which surface-wide or structured coating of the substrate 3 coated with the release agent 1 can be achieved is nevertheless also suitable. If structured coating is desired, then it is preferable to use a printing method.

The upper and lower sides of the substrate 3 coated with the release agent may be coated either simultaneously or successively.

The substrate 3 may be rigid or flexible. As an alternative, instead of the substrate 3 provided as a plate, it is also possible to use a foil. In the case of continuous process management, the foil is preferably provided as an endless foil which is used in a roll-to-roll process.

After the base layer 11 has been applied, it is at least partially dried and/or at least partially cured. This is done for example by exposure to an IR radiator 15. Depending on the matrix material of the dispersion 5, any other method known to the person skilled in the art, by which the base layer 11 can be at least partially cured and/or dried, is nevertheless also suitable. Such methods have been described above.

After at least partially drying and/or at least partially curing the base layer 11, it is preferable for the electrolessly and/or electrolytically coatable particles contained in the base layer 11 to be at least partially exposed. This is done for example by washing with a solution containing potassium permanganate. As an alternative, any other of the oxidizing agents or solvents mentioned above may nevertheless also be used for exposing the electrolessly and/or electrolytically coatable particles. The exposure is for example carried out by spraying the base layer 11 with the oxidizing agent, for example potassium permanganate. The exposure of the electrolessly and/or electrolytically coatable particles is carried out in an activation zone 17, and is represented only schematically here. The exposure is followed by a washing process, in order to remove the residual oxidizing agent or solvent from the substrate 3 coated with the base layer 11 and the release agent 1. This is done in a washing zone 19, and is likewise represented only schematically here.

After the washing in the washing zone 19, the base layer 11 with the now exposed electrolessly and/or electrolytically coatable particles is coated electrolessly and/or electrolytically with a metal layer. This is done in a coating zone 21. The electroless and/or electrolytic coating may in this case be carried out according to any method known to the person skilled in the art. The coating zone 21 is generally followed by a second washing zone 23. In the second washing zone 23, residues of the electrolyte from the electroless and/or electrolytic coating are washed off.

Conventionally the electrolyte solution for the electroless and/or electrolytic coating is not sprayed on, as represented here in FIG. 1, rather the substrate 3, which is coated with the release agent 1 and the base layer 11, is immersed into the electrolyte solution. Nevertheless, any other method known to the person skilled in the art, by which the base layer 11 can be coated electrolessly and/or electrolytically, is also suitable. The electrolessly and/or electrolytically coatable particles in the base layer 11 may also be exposed by immersion in an oxidizing agent or solution. It is also possible to carry out the washing not by spraying the substrate 3 but by immersion into a washing solution. Any other suitable method known to the person skilled in the art may also be used for exposing the electrolessly and/or electrolytically coatable particles from the base layer 11, and for washing the substrate 3 which is coated with the release agent 1 and the base layer 11.

After the electroless and/or electrolytic coating, the substrate 3 is coated with the release agent 1, the base layer 11 which contains the electrolessly and/or electrolytically coatable particles, as well as a metal layer 25.

In order to produce the metal-coated base laminate, an electrically nonconductive material, from which a support is made, is put onto the substrate 3 coated in this way.

In order to produce the base laminate, the support is laminated onto the metal layer 25. This is preferably done by compression, as is represented schematically in FIG. 2.

In order to produce the metal-coated base laminate, a stack 35 in which substrates 3 coated with the release agent 1, the base layer 11 containing the electrolessly and/or electrolytically coatable particles and the metal layer 25, and formable electrically nonconductive material 37 are interleaved alternately, is held between a first die 31 and a second die 33 of a press, for example a hydraulic press. It is of course also possible for the stack to contain only one coated substrate 3. If the method is carried out continuously and an endless foil is used instead of the substrate 3, then it is preferable for the stack to be fed between two rollers and thereby compressed.

As mentioned above, the formable electrically nonconductive material 37 is for example a reinforced or unreinforced plastic, for example a glass fiber-reinforced epoxy resin. The termination of the stack 35 is formed by an upper substrate 39 which is coated only on one side with the base layer 11 that contains the electrolessly and/or electrolytically coatable particles and with the metal layer 25. The base layer 11 and the metal layer 25 are in this case directed toward the formable electrically non-conductive material 37. The lower termination of the stack 35 is formed by a lower substrate 41 that is likewise coated only on one side with the base layer 11 and the metal layer 25, the base layer 11 and the metal layer 25 facing in the direction of the formable electrically nonconductive material 37. For technical fabrication reasons, however, it is also possible for the upper substrate 39 and the lower substrate 41 to be provided with the base layer 11 and the metal layer 25 both on their upper side and on their lower side. The upper substrate 39 and the lower substrate 41 are preferably plates.

An upper depressor 43 is placed between the upper substrate 39 and the second die 33, and a lower depressor 45 is placed between the lower substrate 41 and the first die 31.

In order to produce metal-coated base laminates from the formable electrically nonconductive material 37, the metal layers 25 and the base layer 11 containing electrolessly and/or electrolytically coatable particles, a pressing force is exerted on the first die 31 and the second die 33. The stack 35 is thereby pressed. The exertion of the pressing force is represented symbolically by the arrows 47 and 49. By exerting the pressing force 47, 49, the formable electrically nonconductive material 37 which is contained between the substrates 3 coated with the release agent 1, the base layer 11 containing electrolessly and/or electrolytically coatable particles and the metal layer 25, is compressed. At the same time, the formable electrically nonconductive material 37 is at least partially cured to form base laminates. Owing to the release agent 1, the substrates 3 can easily be removed again after the curing. This leaves a layer of the metal layer 25 and possibly also a part of the base layer 11, which contains the electrolessly and/or electrolytically coatable particles, on the cured nonconductive material which forms the support.

The substrate 3 is preferably made from a metal. The substrate 3 is therefore a good conductor of heat, so that heat can also be supplied to the formable electrically conductive material 37 in order to achieve uniform curing at least partially. The compression of the formable electrically nonconductive material 37 is preferably carried out at an elevated temperature relative to the ambient temperature.

In order to be able to remove the upper substrate 39 more easily from the upper depressor 43 and the lower substrate 41 more easily from the lower depressor 47, those surfaces respectively of the upper substrate 39 and the lower substrate 41, which face the upper depressor 43 and the lower depressor 45, are preferably likewise coated with release agent 1.

After at least partially curing the formable electrically nonconductive material 37, the pressing force 47, 49, which is exerted on the first die 31 and the second die 33, is released. The stack 35 of the substrates 3 coated with the release agent 1, as well as the metal-coated base laminates that have been produced, is taken out. The metal-coated base laminates between the substrates 3 coated with the release agent 1 are subsequently removed. Owing to the release agent 1, the base layer 11 does not adhere to the substrates 3. The substrates 3 can therefore be removed without the metal coating, comprising the metal layer 25 and the base layer 11, on the support not being damaged. After removing the metal-coated base laminates, the substrates 3 coated with the release agent 1 are used again to produce further metal-coated base laminates. If the release agent 1 has been firmly connected to the substrate 3, for example by chemically bonding the release agent 1 to the substrate 3, then the substrates 3 may be reused directly by applying a new base layer 11 that contains electrolessly and/or electrolytically coatable particles, which is subsequently provided with a metal layer 25 by electroless and/or electrolytic coating, and applying further formable electrically non-conductive material 37 thereon.

If the release agent 1 is not firmly connected to the substrate 3, then it is initially necessary to apply a new layer of release agent 1, before the dispersion 5 is applied in order to form the film.

The release agent 1 may be applied by any application method known to the person skilled in the art. For example, it is possible to apply the release agent 1 by a plasma method, doctor blading, casting, spraying, roller coating, printing, painting or the like.

The formable electrically nonconductive material 37 is preferably applied in the form of semi-cured plastic plates. As an alternative, it is also possible for the formable electrically nonconductive material 37 to be placed in the form of resin-impregnated fibers or mats onto the substrate 3 coated with the release agent 1, the base layer 11 containing electrolessly and/or electrolytically coatable particles and the metal layer 25. The placement is in this case carried out in a way known to the person skilled in the art.

In a continuous method not only is an endless foil preferably used instead of the substrate 3 designed as a plate, but also the formable electrically nonconductive material is preferably provided in the form of an endless foil which can be processed in a roll-to-roll method.

After the pressing represented in FIG. 2, it may sometimes be necessary to apply a further metal layer onto the support provided with the metal layer 25 and optionally the base layer 11, which contains the electrolessly and/or electrolytically coatable particles. This is schematically represented in FIG. 3.

By the lamination, the metal layer 25 is bonded to the electrically nonconductive material which forms the support 51. The support 51 has been produced by compressing and curing the formable electrically nonconductive material 37. On the outer side of the support 51, the base layer 11 or residues of the base layer 11, which contains the electrolessly and/or electrolytically coatable particles, may possibly remain applied on the metal layer 25. Since the electrolessly and/or electrolytically coatable particles 11, which are contained in the base layer 11, are generally not connected to one another, the upper side of the metal-coated support 51 may possibly not be electrically conductive. For this reason, it may be necessary to apply a further metal layer 53 on the base layer 11, or to remove the base layer 11. The base layer 11 may for example be removed chemically, for example in an activation bath, or mechanically, for example by brushing or sandblasting. The further metal layer 53 will be applied by methods known to the person skilled in the art. The further metal layer may consist of the same metal or a different metal. So that the metal for the further metal layer 53 adheres on the base layer 11, which contains the electrolessly and/or electrolytically coatable particles, it is preferable to expose the electrolessly and/or electrolytically coatable particles first. This is generally done in an activation zone 55. As described above, the exposure is in this case carried out for example by treatment with an oxidizing agent or a solvent. Suitable solvents and oxidizing agents have likewise been described above. As an alternative, it is possible to expose the electrolessly and/or electrolytically coatable particles physically or mechanically. If the exposure is carried out chemically, then it is possible to bring the activating agent, for example an oxidizing agent or a solvent, in contact with the base layer 11, which contains the electrolessly and/or electrolytically coatable particles, by spraying. As an alternative, it is also possible to immerse the support 51 with the metal layer 25 and the base layer 11 into the activating agent.

After the electrolessly and/or electrolytically coatable particles have been exposed, residues of the solvent or oxidizing agent are preferably washed off from the support 51, which is coated with the base layer 11 and the metal layer 25. This is done for example in a washing zone 57. For the washing, the support 51 may for example be sprayed with a washing agent, for example an aqueous acidic solution containing hydrogen peroxide or an acidic solution containing hydroxylamine nitrate. As an alternative, for example, it is also possible to immerse the support 51. The washing zone 57 is followed by a coating zone 59, in which the base layer 11 containing electrolessly and/or electrolytically coatable particles is coated electrolessly and/or electrolytically with the further metal layer 53. The electroless and/or electrolytic coating may in this case be carried out in any way known to the person skilled in the art. In general, the electroless and/or electrolytic coating will be carried out as described above.

In order to remove residues of the electrolyte solution from the support 51 coated with the further metal layer 53, the base layer 11 possibly still present and the metal layer 25 after the electroless and/or electrolytic coating, the support 51 with the layers 25, possibly 11, 53 is preferably washed in a second washing zone 61 after the electroless and/or electrolytic coating. The washing is generally carried out with water.

In the case of a sufficiently thin base layer 11, which contains the electrolessly and/or electrolytically coatable particles, it is possible for the electrolessly and/or electrolytically coatable particles contained in the base layer 11 to be replaced with metal ions from the electrolyte solution by the electroless and/or electrolytic coating. In this case a virtually to fully continuous metal layer 53 is applied on the support 51. When the metal layers 25 and 53 coalesce, this gives a uniform continuous metal layer on the support 51.

The further metal layer 53 produced by the method according to the invention, or the uniform continuous metal layer, may have any desired thickness, depending on the way in which the electroless and/or electrolytic coating method is carried out. The method according to the invention is advantageous for the production of layer thicknesses in the range of from 0.1 to 25 μm, preferably for layer thicknesses in the range of from 1 to 10 μm, and in particular for layer thicknesses of from 2 to 6 μm.

After the metal layer 53 has been applied, the metal-coated base laminate produced in this way, which comprises the support 51 with the metal layers 25 and 53 as well as optionally the base layer 11, may be processed further. This is done, for example, by general processing methods for printed circuit boards such as are known to the person skilled in the art.

The metal-coated base laminates according to the invention may be used for example to produce printed circuit boards. Such printed circuit boards are for example those with multilayer inner and outer levels, micro-vias, chip-on-boards, flexible and rigid printed circuit boards, for example installed in products such as computers, telephones, televisions, electrical components of automobiles, keyboards, radios, video, CD, CD-ROM and DVD players, game consoles, measuring and regulating equipment, sensors, electrical kitchen appliances, electrical toys etc.

The metal-coated base laminates according to the invention may furthermore be used to produce RFID antennas, transponder antennas or other antenna structures, chip card modules, flat cables, seat heaters, foil conductors, conductor tracks in solar cells or in LCD/plasma screens, capacitors, foil capacitors, resistors, convectors, electrical fuses or to produce electrolytically coated products in any form, for example polymer supports clad with metal on one or two sides with a defined layer thickness, 3D molded interconnect devices or to produce decorative or functional surfaces on products, for example to shield against electromagnetic radiation, for thermal conduction or as packaging. Furthermore, the polymer-coated metal foils may also be used to produce contact points or contact pads or interconnections on an integrated electronic component, as well as to produce antennas with contacts for organic electronic components. Use is furthermore possible in the context of flow fields of bipolar plates for application in fuel cells. It is furthermore possible to produce a surface-wide or structured electrically conductive layer for the subsequent decorative metallization of supports, such as, for example, decorative parts for the motor vehicle sector, sanitary sector, toy sector, household sector, and office sector, and packaging, and also foils. It is furthermore possible to produce thin metal foils, battery foils or polymer supports clad on one or two sides. The polymer-coated metal foils may also be employed in fields for which good thermal conductivity is advantageous, for example in foils for seat heaters, floor heaters and insulating materials.

The polymer-coated metal foils according to the invention are preferably used to produce printed circuit boards, RFID antennas, transponder antennas, seat heaters, flat cables, contactless chip cards, thin metal foils or polymer supports clad on one or two sides, foil conductors, conductor tracks in solar cells or in LCD/plasma screens or to produce decorative products, for example for packaging materials.

### LIST OF REFERENCES

1 release agent
3 substrate
5 dispersion
7 roller
9 container
11 base layer
13 container
15 IR source
17 activation zone
19 washing zone
21 coating zone
23 second washing zone
25 metal layer
31 first die
33 second die
35 stack
37 formable electrically nonconductive material
39 upper substrate
41 lower substrate
43 upper depressor
45 lower depressor
47, 49 pressing force
51 support
53 metal layer
55 activation zone
57 washing zone
59 coating zone
61 washing zone

1.-26. (canceled)

27. A method for producing metal-coated base laminates comprising:
(a) applying a base layer onto a substrate, with a dispersion comprising electrolessly and/or electrolytically coatable particles in a matrix material;
(b) at least partially curing and/or drying the matrix material;
(c) forming a metal layer on the base layer by electroless and/or electrolytic coating;
(d) laminating a support made of an electrically nonconductive material onto the metal layer;
(e) removing the support laminated with the metal layer from the substrate; and
(f) removing the base layer, which is connected to the metal layer laminated onto the support after removing the substrate.

28. The method of claim 27, wherein the substrate is a plate or a foil coated with a release agent.

29. The method of claim 27, wherein the substrate is a foil or a plate made of a release agent.

30. The method of claim 27, further comprising depositing a metal electrolessly and/or electrolytically onto the base layer, which is connected to the metal layer laminated onto the support, after the removing step (e).

31. The method of claim 27, further comprising at least partially exposing the electrolessly and/or electrolytically coatable particles.

32. The method of claim 30, further comprising at least partially exposing the electrolessly and/or electrolytically coatable particles contained in the base layer, which is connected to the metal layer laminated onto the support, after removal from the substrate.

33. The method of claim 31, wherein the at least partially exposing the electrolessly and/or electrolytically coatable particles is carried out chemically, physically or mechanically.

34. The method of claim 31, wherein the at least partially exposing the electrolessly and/or electrolytically coatable particles is carried out with an oxidizing agent.

35. The method of claim 34, wherein the oxidizing agent is selected from the group consisting of: potassium permanganate, potassium manganate, sodium permanganate, sodium manganate, hydrogen peroxide or its adducts, a perborate, a percarbonate, a persulfate, a peroxodisulfate, sodium hypochloride, and a perchlorate.

36. The method of claim 31, wherein the at least partially exposing the electrolessly and/or electrolytically coatable particles is carried out by one or more substances which are capable of dissolving, etching and/or tumescing the matrix material.

37. The method of claim 36, wherein the one or more substances is an acidic chemical, an alkaline chemical, a chemical mixture, or a solvent.

38. The method of claim 27, further comprising at least partially removing an oxide layer from the electrolessly and/or electrolytically coatable particles before step (c) and/or before the electroless and/or electrolytic coating of metal in the further step after removing the substrate.

39. The method of claim 27, wherein the applying step (a) is performed in a structured fashion or surface-wide onto the substrate by a coating method.

40. The method of claim 27, wherein the metal layer is applied on an upper side and a lower side of the support.

41. The method of claim 27, wherein the substrate is a plate and wherein the laminating step (d) comprises applying the support in form of a viscous liquid onto the plate coated with a release agent and the base layer.

42. The method of claim 27, wherein the substrate is a plate and wherein the laminating step (d) comprises applying the support in form of resin-impregnated fibers, mats or incompletely cured plastic plates onto the plate coated with a release agent and the base layer.

43. The method of claim 27, wherein the substrate is a plate and further comprising applying a release agent is applied onto the plate by applying a release agent level or by coating the plate with a second dispersion containing the release agent.

44. The method of claim 27, wherein the substrate is a plate and wherein a release agent is applied onto the plate by a plasma method.

45. The method of claim 27, wherein the substrate comprises a release agent having a surface tension relative to air of less than 25 mN/m.

46. The method of claim 27, wherein the substrate comprises a release agent selected from the group consisting of: polyvinyl alcohol, silicone polymers, fluoropolymers, low molecular weight fats, waxes or oils.

47. The method of claim 27, further comprising removing at least a part of the base layer from the substrate.

48. The method of claim 47, wherein the removing at least a part of the base layer from the substrate is performed after step (d).
